(19) United States
(12) Patent Application Publication
(10) Pub. No.: US 2025/0269979 A1
(43) Pub. Date: Aug. 28, 2025

(54) BAGGAGE TRANSFER DEVICE FOR AIRCRAFT

(71) Applicant: Leslie D Weaver, Palm Beach Gardens, FL (US)

(72) Inventor: Leslie D Weaver, Palm Beach Gardens, FL (US)

(21) Appl. No.: 19/047,785

(22) Filed: Feb. 7, 2025

Related U.S. Application Data
(60) Provisional application No. 63/551,884, filed on Feb. 9, 2024.

(51) Int. Cl. B64F 1/32

(52) U.S. Cl. CPC B64F 1/324

(57) ABSTRACT

A baggage transfer device for aircraft. The device is placed in the cargo area of an aircraft providing a lifting mechanism to safely and efficiently transfer baggage between a ramp surface and a cargo entry. The baggage transfer device is operated on 24 VDC using either a fiber cable or driveshaft for moving a trolley mechanism along a track.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/551,884, entitled “BAGGAGE TRANSFER DEVICE FOR AIRCRAFT”, filed Feb. 9, 2024. The contents of the above referenced application is incorporated herein by reference in its entirety.

### FIELD OF THE INVENTION

This invention relates generally to the aviation field and, in particular, to a baggage transfer device for moving baggage between the ramp surface and cargo entry of aircraft.

### BACKGROUND OF THE INVENTION

For purposes of this disclosure, baggage and luggage, terms used interchangeably, are defined as personal belongings packed in suitcases, backpacks, duffle bags, and the like containers that are shipped in the baggage area of an aircraft. The size of the baggage depends upon personal preference and the weight depends upon what is being shipped in the baggage. A problem, to which this disclosure addresses, if the lifting of the baggage into the cargo areas of large general aviation aircraft and business jets.

Lifting heavy baggage into an aircraft can pose several challenges and potential problems, both for the individuals handling the baggage and for the overall safety of the aircraft. Many modern airports use systems such as conveyor belts and cargo loaders to handle baggage more efficiently and with less physical strain on personnel. However, not all airports may have access to these advanced systems. Further, conventional conveyor systems designed for larger commercial aircraft may not work well with business jets and general aviation. A unique benefit of business jets and general aviation aircraft is the ability to land at Class C, D or even Class E airports most of which are not equipped with conveyor systems for loading and unloading baggage. The problem is the elevated cargo door entry found on business jets that can travel to smaller airport yet require loading and unloading of baggage from elevated baggage platforms.

Lifting heavy baggage can put a significant strain on the muscles and joints of the individuals handling the baggage. This can lead to musculoskeletal injuries, especially if proper lifting techniques are not followed. The amount of weight a person can safely lift over their depends on various factors, including their individual strength, fitness level, and overall health. However, any individual lifting heavy, awkward shaped baggage is put at risk.

Airport personnel who handle baggage for a living are often trained in proper lifting procedures to minimize the risk of injury. Many airport operations must comply with regulatory standards regarding the handling and loading of baggage. Failure to adhere to these standards can lead to safety violations and regulatory consequences. Such training and requirements are not typically found at smaller airports where the airport personnel are multitasked. Personnel who repeatedly lift heavy baggage may be at risk of developing chronic health issues, such as back pain, muscle strains, and repetitive stress injuries. For this reason, some airport personnel may refuse to unload the baggage area without equipment essential to mitigating these risks.

Loading and unloading heavy baggage manually can be also be time-consuming and may cause delays in the turnaround time of an aircraft. This can impact the overall efficiency of airport operations, especially during busy periods when quick aircraft turnaround is crucial.

What is lacking in the industry is a baggage transfer device capable of transferring baggage between the ramp surface and the entry of the baggage cargo door to eliminate manual lifting.

### SUMMARY OF THE INVENTION

A baggage lifting device for aircraft. The device is placed in the cargo area of an aircraft and will provide the necessary lifting capability to safely and efficiently lift baggage from between the ramp surface and the cargo area.

It is an objective of the invention to provide a device that is adaptable to most raised cargo areas and will enable an operator to easily, quickly and safely load and unload baggage onto the aircraft.

Still another objective of the invention is to provide a device that is lightweight, adaptable, and beneficial to aircraft ownership and operating personnel.

Yet still another objective of the invention is to provide a device that is adjustable to enable installation into various aircraft with the ability to have an independent battery or employ the aircraft battery.

Still another objective of the invention is to provide a device that will provide a simple, convenient solution to loading baggage avoiding the risk of injuring personnel attempting to move heavy baggage being shipped on an aircraft.

Another objective of the invention is to provide a device that is of particular benefit for baggage loading of aircraft with a high ramp stature including, but not limited to, Gulfstream, Globals, Challengers, Falcons, Embraers, Airbus business jet and Boeing business jet aircraft.

Still another objective of the invention is to include a counter for weight measurement of the baggage being loaded to assure required weight and balance is within range.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE DRAWINGS

FIG. 1 is a perspective view of a baggage lifting device collapsed;

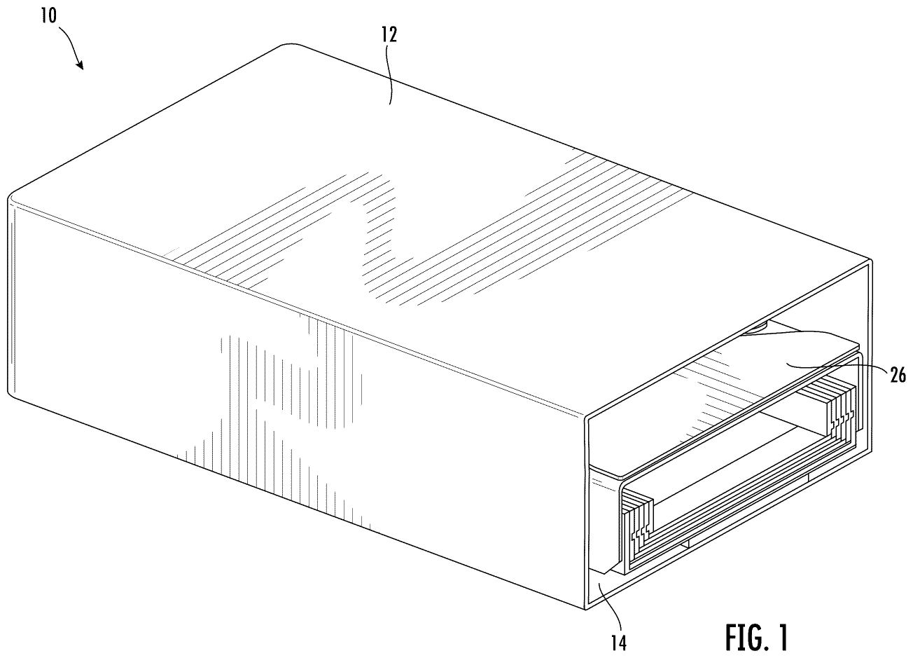

FIG. 2 is a perspective view of the baggage lifting device with a trolley mechanism retracted and folded;

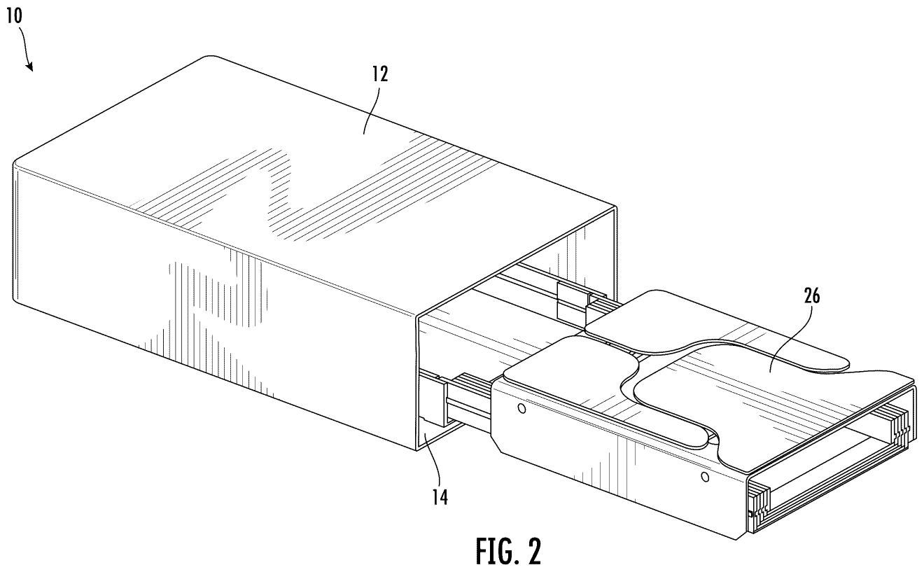

FIG. 3 is a perspective view of the baggage lifting device with the trolley mechanism retracted and unfolded;

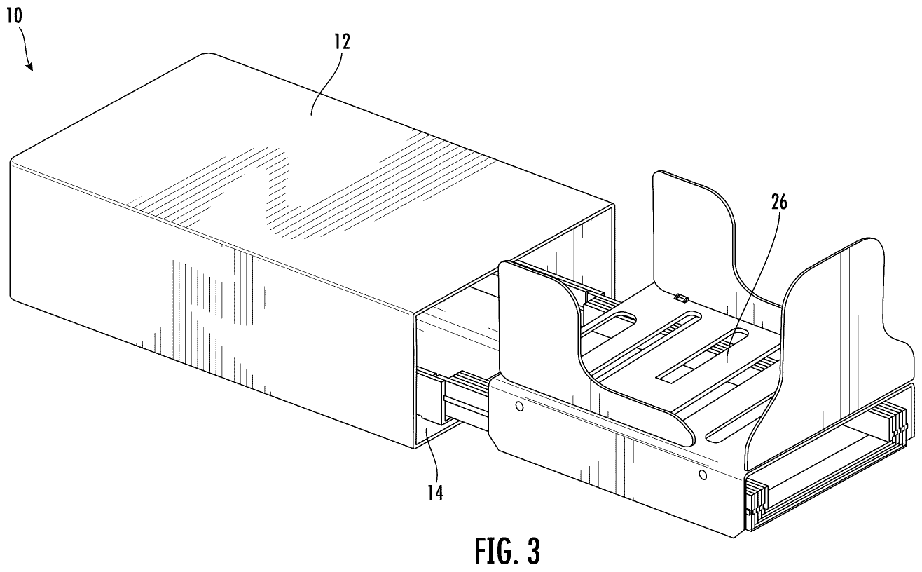

FIG. 4 is a perspective view of the baggage lifting device entirely retracted having a trolley mechanism slidably secured to a track;

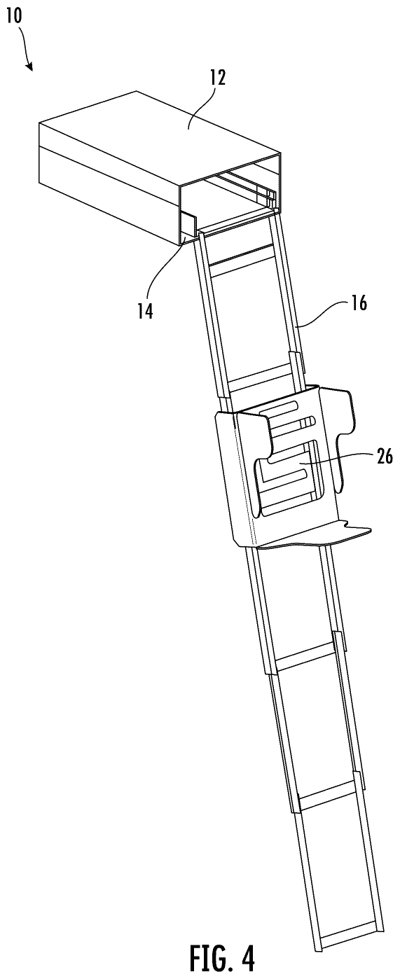

FIG. 5 is a side view of the baggage lifting device collapsed;

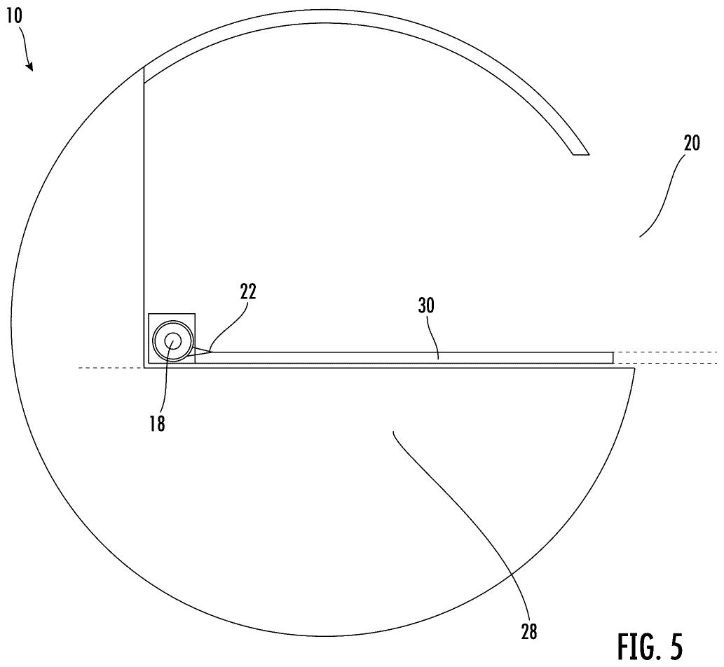

FIG. 6 is a side view of the baggage lifting device entirely retracted having a trolley mechanism slidably secured to a track; and

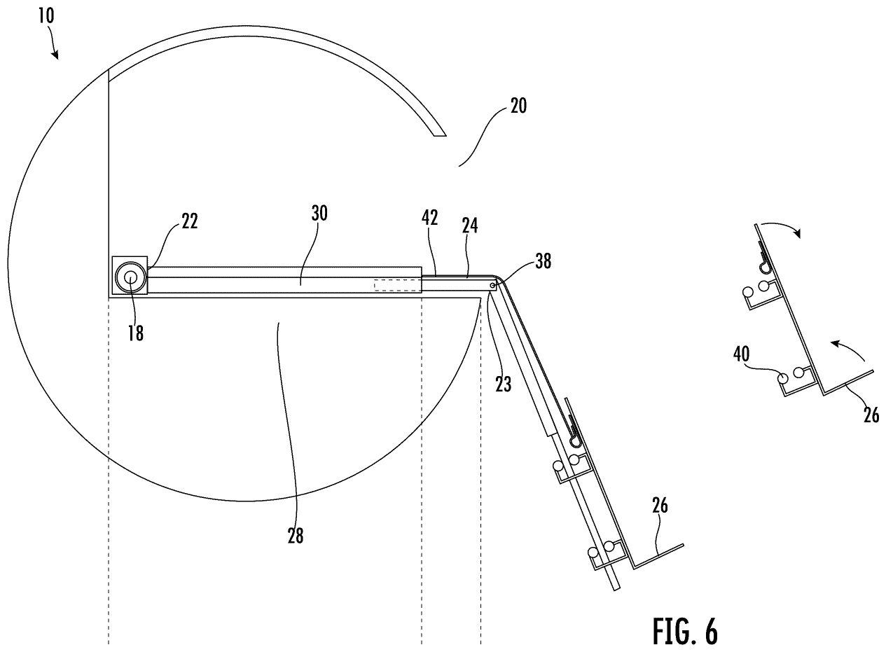

FIG. 7 is a perspective view of an alternative embodiment of the baggage lifting device employing a gear motor.

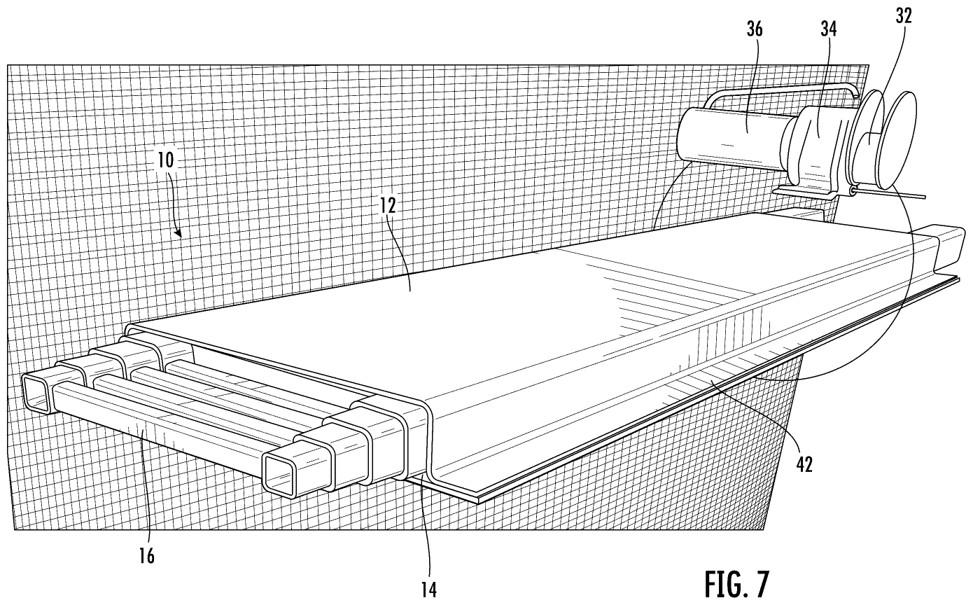

### DESCRIPTION OF THE PREFERRED EMBODIMENT

It is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

The instant invention is a freestanding device that will be placed in the cargo area of an aircraft and will provide the necessary lifting capability to safely and efficiently lift baggage from the ramp up and into a position where a crewmember in the aircraft can then move the baggage into the cargo hold, eliminating any lifting necessary from crewmembers on the ground.

In a first embodiment the device 10 will be freestanding and battery operated. By avoiding any attaching of the device to the floor of the cargo area, and hard wiring the device into the aircraft electrical system, the device 10 will not require any certification from the FAA. In a second embodiment, requiring FAA certification, the device 10 is mounted and drawing power from the aircraft batteries.

When not in use, the device has a very low profile of approximately 2.5 inches and can be even lower if the operator cuts the carpet and floor insulation and fit carpet around the loader. Width is about 10 inches wide. The overall weight is less than 45 pounds.

In one embodiment the device is housed 12 in an internal chamber, or a tunnel 14, that contains a telescoping track 16 that extends out and hinges so the track can rotate down to the ramp surface. A motor drive unit 18 located at the opposite end of the door opening 20 will contain a pulley 22 and cable 24 that will provide the lifting and lowering of a trolley mechanism 26 that the baggage can rest upon. This tunnel 14 allows the operator to completely load the cargo area 28 with baggage and when finished, the telescoping track 16 neatly and easily stows back into the aircraft so the door can be closed. The term “cargo area” is used interchangeably with the term “baggage area.”

Power will come from a 24-volt battery pack complete with remote operating FOB's. Batteries are 12-volt, sealed non-spillable lead acid, completely safe and certified for aviation shipping. The battery pack can be charged and maintained continuously from the aircrafts electrical system.

The telescoping track 16 will be able to accommodate several aircraft types, with cargo floor heights from 75 to 100 inches off the ground, which is standard in all general aviation aircraft.

The motor unit 18 will be placed at the back of the baggage area 28 and will be covered. The unit creates a tunnel so the baggage area 28 can be packed normally, and the telescoping ladder 16 can then be stowed into the plane uninhibited. In one embodiment, the device 10 will be portable with power coming from a 24 VDC battery pack with wireless, remote control operation. Batteries will be sealed, non-spillable lead acid batteries approved for aviation with no restrictions. In another embodiment, charging can take place with a trickle charger plugged into the planes power. Still another embodiment is for installation of the device 10 permanently to the plane via an STC or a 337. The ladder pulls out telescopically and rotates downward to contact the ramp surface to accommodate aircraft of varying heights. A light weight trolley 26 will support the suitcase as it is lifted to a position where a person in the baggage area 28 can pull it into the aircraft.

A 6-foot lift should not take more than 5-6 seconds. Although 6 seconds seems to be a long time, the rate is balanced for speed and safety. A cycle time will be less than 30 seconds. After the first 2 or 3 bags, the personnel stacking the luggage will need appropriate time to arrange bags in cargo area 28. If the lift travels at about 12″-14″ per second, a travel time of 12″ per second is 720″/min.

Electrical power to the device 10 is preferred at 28 VDC. All aircraft targeted use 28 VDC power so it will be a readily available source. The lift may be designed to each specific aircraft using an STC. Controls allow for up and down movement with an on/off switch and circuit breaker protection. In addition, a means of limiting the up and down movement is provided without the need of limit switches that otherwise add components and increases the opportunity for failure due to the additional wiring. Torque limitations are included to remove the chance for unnecessary damage to component parts due to jam or other obstruction in the travel of the carriage.

The drive system is an electrical motor 18 wherein there is a direct relationship between a gear motor 34 output RPM and the torque available. In addition, the RPM output of the gear motor 34 coupled with the diameter of the pulley 22 determines the speed of the carriage 26. The device 10 is geared to cycle at a speed quick enough to make it practical to use, but not so fast as to create a hazard. For instance, about 12 inches per second is a contemplated speed. This speed will make a six-foot lift in six seconds; the speed can be adjusted to the operator's preference. In this example, each up-unload-down cycle is less than 30 seconds and employs about 120-inch pounds output from the gear motor 34. Both parallel and right-angle motors may be used, depending upon the drive system chosen.

The motor 18 in the drive mechanism has the largest cross section area positioned at the back of the baggage area 28, away from the entry door 20. This will require a drive shaft 30 to extend from the motor, which is at the back of the baggage area 28 to the front of the base plate 42 structure near the door 20. An engagement exists between the drive gear and the axle, where engagement takes place, as the track 16 is extended of operation. A locking mechanism may be required to keep both gears engaged for proper operation. Most aircraft doors designs are not exceptionally large and the amount of space consumed by the instant invention is kept at an absolute minimum. Placing the motor 18 at the back of the baggage area 28 accomplishes this. In one embodiment, a direct drive system employs a pulley 22 containing a drive cable 24 connected directly to a gear motor 34. The pulley 22 can be sized to a diameter close to the cross section of the gear motor 34, which allows flexibility in motor speed and torque options. The cable 24 travels down a tunnel 14 to the front of the unit where it would exit the plane and attach to a carriage 26. This option provides the greatest flexibility in pulley 22 diameter design, allows adjustment in length of the housing 12 on the floor for different widths of aircraft, and uses the fewest parts. An alternative embodiment will again place the motor 18 at the back of the baggage area 28 and have a drive shaft 30 extending forward to the front of the loader where a mechanism would be developed to connect a drive gear to a second gear that is attached to a jack shaft that is an integral part of the track 16. The two gears would mesh as the track 16 is extended from the plane. A locking lever could capture both pieces and prevent the two parts from separating, thusly keeping the gears engaged. The challenge with this design will be the limiting size of the jack shaft 32 that the cable 24 will be wrapped around. The shaft 30 must be able to fit within the housing 12 attached to the floor and should not be larger than the track 16 itself. The smaller diameter shaft means a higher RPM will be necessary to attain the same lift rate. Increasing the RPM's means lowering the torque so a more powerful motor might be necessary. Also, the driveshaft 30 will need to be extendable or collapsible to allow for different baggage area 28 widths for the aircraft being used.

In one embodiment, a drive pulley 22 is placed at the aft of the baggage area 28 and directly attached to the gear motor 34. The attachment rope 24 would extend to through a tunnel 14 to the front or baggage door 20 end of the track housing 14, where it would pass over an idler pulley 23 to lift the load up a track 16. The second embodiment would be to have a drive axle 36 mounted at the head of the pull out track sections. An axle mount that is near the baggage door 20 (forward mount) is small in diameter and an axle/pulley is mounted in the aft of the baggage area 28 near the motor 18 could be larger in diameter, up to the size where it is equal to, but doesn't exceed, the size of the gear motor 34. An aft mount would require an additional 5 feet of belt/cable/rope 24, but utilizing a larger pulley easily accommodates that, while offering a slower output from the gear motor 34. The forward mount would use an axle 36 no larger than about 2″. For instance, a 14″ rope/cable 24 would require 14 wraps on the axle 36, which would be 3-1″ in width. (6″ per rev so 7′ would required 14 revs at 14″ of width per wrap=3½″). Factoring in the RPM to torque value of a motor 18, a small diameter pulley 22 means that the RPM output of the motor will have to be higher. The higher the RPM output means less gearing, which means less torque output. Preferably the optimum range is in the 125-150 inch pounds of torque. For instance, a 2″ pulley would have a take-up rate of 6.28″ per revolution, which would require approximately 120 RPM output from the gear motor. A 3″ pulley would have a take-up rate of 9.4″ per revolution, which would require approximately 77 RPM.

In a preferred embodiment, Amstel® Blue rope is stronger than steel, has no memory, does not stretch, is abrasion resistant, and of negligible weight. The rope selected is made for crane application allowing a certification. For instance, a ¾ inch rope has a 7700 pound certified minimum rating. A ⅛ inch rope has a certified rating of 2300 pounds. The track 16 will consist of two separate components. First will be the housing 12 or tunnel 14, which will be attached to the plane within the baggage area. It will provide the rigidity of the system, mounting the motor 18 at the back end and the track 16 and carriage 26 at the front end. It will be an open channel design in which the track 16 will extend into and out of. It will be enclosed with a cover that will be attached with quick fasteners to allow for easy access should the need arise. The primary function of this component will be to provide a clear area for the track 16 to be slid into for stowing while allowing the baggage area 28 to be loaded. As previously discussed, space within the baggage area 28 and specifically the baggage door 20 is a premium so the height of this unit should be kept to a minimum. Preferably, not more than three inches.

The track 16 is telescoping. The top or main section will remain partially in the aircraft and attached to the tunnel. It will be hinged 38 to allow a downward angle once outside of the plane. The hinge point 38 will also locate an idler pulley 23 where the cable will rest upon to raise and lower the carriage. The other two sections will extend downward as necessary to reach the ground and will provide rigidity for carriage travel. The lower section of the track should be collapsible to provide damage protection should the aircraft squat during fueling for loading with the baggage loader extended. In the preferred embodiment, the track 16 will accommodate all platforms. This spans roughly baggage floors that are 72″ to 90″ above the ramp. Sections of the track 16 must fit inside of each other to reduce storage space, and at least one section, probably the lower section, must be collapsible so as to not damage the luggage or aircraft after loading.

The carriage 26 is the interface between the machine and the operator. A small, lightweight, folding carriage 26 will be required. It must attach and detach to the track quickly and be large enough to stabilize a large suitcase, but no larger. The carriage has rollers 40 constructed and arranged to accommodate the load of a 100-pound suitcase and handle the small bumps as it travels up and down the track 16. The carriage 26 attaches and detaches quickly. Preferably the carriage 26 has wheels 40 at the four corners on the top for load bearing, and two wheels on the back side for stability. An L shaped platform can be of a folding design for easy storage and be large enough to stabilize a large suitcase design. The platform will attach quickly to the cable 24 and will be hoisted up the incline, while using gravity for the decent.

On a Global the distance from the back of the baggage areal to the front is roughly 66 inches, with the tail section being roughly 82 inches off the ground, for a total length of 150 inches. A Gulfstream 1150 is approximately 58 inches front to back, and stands 88 inches off the ground. A cable length, with a couple wraps left on the spool, would be 12.13 feet long, considering that the rope attached to the carriage will not extend all the way to ground. Using a base plate 42 that is mounted to the floor allows ease of adjustability in length to accommodate the fuselages of most aircraft, specifically, Gulfstream, Globals, Challengers and Embraers.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein. For instance, the instant invention can be adapted for use with ships, trains and other vessels or apparatuses.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A baggage lifting device for aircraft comprising:
a housing securable to an aircraft cargo area, said housing forming a chamber;
a telescopic track having a proximal end slidably secured to said chamber wherein said track includes a hinge mechanism that extends outwardly from said chamber allowing a distal end of said track to extend to a ramp surface; and
a motor drive unit positioned at said proximal end for use in moving a trolley mechanism slidably secured to said telescopic track, wherein said trolley mechanism constructed and arranged to support baggage as it is transferred between the ramp surface and the cargo area.

2. The baggage lifting device according to claim 1, wherein said housing has a profile of approximately 2.5 inches high, a width of approximately 10 inches, and a length sufficient to extend from the cargo area to the ramp surface.

3. The baggage lifting device according to claim 1, wherein said telescopic track is retractable into said chamber.

4. The baggage lifting device according to claim 1, wherein said motor drive unit is powered from a rechargeable 24 VDC battery pack.

5. The baggage lifting device according to claim 1, wherein said motor drive unit is coupled to the aircraft battery.

6. The baggage lifting device according to claim 1 including a remote controller for movement of said trolley.

7. The baggage lifting device according to claim 1, wherein a gear motor is coupled to a pulley sized to move said trolley mechanism at about 12 inches per second.

8. The baggage lifting device according to claim 7, including a pulley placed at the aft of the cargo area and directly attached to said gear motor.

9. The baggage lifting device according to claim 1, including a cable made of Amstel® Blue rope having a certified minimum rating between 2300 pounds and 7700 pounds for engaging said pulley and said motor drive.

10. The baggage lifting device according to claim 1, wherein an idler pulley is located at said hinge allowing said cable to extend from a horizontal position to a substantially vertical position for use in raising and lowering said trolley mechanism.

11. The baggage lifting device according to claim 1 including a drive shaft extending from said motor drive unit to engage said trolley mechanism, said trolley mechanism having a jack shaft integrated into said telescopic track.

12. The baggage lifting device according to claim 2, wherein the length of said telescopic track is between 1.8 meters (˜72 inches) to 2.3 meters (˜90 inches).

13. The baggage lifting device according to claim 1, wherein said trolley mechanism is detachable from said telescopic track.

14. The baggage lifting device according to claim 1, wherein said trolley mechanism includes rollers constructed and arranged to facilitate movement of baggage along said telescopic track.
